(19) United States
(12) Patent Application Publication
(10) Pub. No.: US 2026/0073215 A1
(43) Pub. Date: Mar. 12, 2026

(54) INFORMATION PROCESSING APPARATUS AND INFORMATION PROCESSING METHOD

(71) Applicant: Panasonic Automotive Systems Co., Ltd., Kanagawa (JP)

(72) Inventors: Kenichi YADANI, Kyoto (JP); Yutaka YOSHIHAMA, Osaka (JP)

(73) Assignee: Panasonic Automotive Systems Co., Ltd., Kanagawa (JP)

(21) Appl. No.: 19/306,469

(22) Filed: Aug. 21, 2025

(30) Foreign Application Priority Data
Sep. 10, 2024 (JP) 2024-156734

(51) Int. Cl. G06N 3/08

(52) U.S. Cl. CPC G06N 3/08

(57) ABSTRACT

An information processing apparatus includes: an NN input component that acquires a neural network including a Transformer; a determiner that determines whether one or more parameters used for the neural network satisfy a specified condition; and a modifier that modifies the one or more parameters to cause the one or more parameters to satisfy the specified condition, when the one or more parameters are determined not to satisfy the specified condition.

### CROSS REFERENCE TO RELATED APPLICATION

The present application is based on and claims priority of Japanese Patent Application No. 2024-156734 filed on Sep. 10, 2024.

### FIELD

The present disclosure relates to an information processing apparatus and the like that perform processing related to machine learning.

### BACKGROUND

In recent years, Transformers have been proposed (for example, see Non Patent Literature (NPL) 1). The Transformer is a deep learning model and is a network architecture in which inputs and outputs are connected by multi-head attention and a feed-forward network. The Transformer is also used for ChatGPT (registered trademark). In NPL 2, a Vision Transformer is proposed as an example of applying the Transformer to an image recognition task. The Vision Transformer can perform image recognition with higher accuracy than convolutional neural networks.

### CITATION LIST

### Non Patent Literature

NPL 1: A. Vaswani, N. Shazeer, N. Parmar, J. Uszkoreit, L. Jones, A. N. Gomez, L. Kaiser, and I. Polosukhin, “Attention Is All You Need”, Conference on Neural Information Processing Systems (NIPS) 2017, pp. 5998-6008
NPL 2: Alexey Dosovitskiy, Lucas Beyer, Alexander Kolesnikov, Dirk Weissenborn, Xiaohua Zhai, Thomas Unterthiner, Mostafa Dehghani, Matthias Minderer, Georg Heigold, Sylvain Gelly, Jakob Uszkoreit, Neil Houlsby, “An Image is Worth 16×16 Words: Transformers for Image Recognition at Scale”, International Conference on Learning Representations (ICLR) 2021, Submitted on Oct. 22, 2020 (v1), last revised on Jun. 3, 2021 (v2)

### SUMMARY

However, the Vision Transformer of NPL 2 can be improved upon.

Therefore, the present disclosure provides an information processing apparatus and the like capable of improving upon the above related art.

An information processing apparatus according to one aspect of the present disclosure includes: an input component that acquires a neural network including a Transformer; a determiner that determines whether one or more parameters used for the neural network satisfy a specified condition; and a modifier that modifies the one or more parameters to cause the one or more parameters to satisfy the specified condition, when the one or more parameters are determined not to satisfy the specified condition.

Note that these comprehensive or specific aspects may be implemented by a system, method, integrated circuit, computer program, or recording medium such as a computer-readable compact disc read-only memory (CD-ROM), or by any combination of the system, method, integrated circuit, computer program, and recording medium. The recording medium may be a non-temporary recording medium.

The information processing apparatus of the present disclosure is capable of improving upon the above related art.

Note that advantages and effects in one aspect of the present disclosure are disclosed from the description and drawings. Such advantages and/or effects are provided using configurations described in some embodiments and the description and drawings, but not all configurations are necessarily required.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a block diagram illustrating an example of the configuration of an information processing apparatus according to an embodiment.

FIG. 2 is a diagram illustrating the configuration of the Transformer.

FIG. 3 is a diagram illustrating the configuration of multi-head attention included in the Transformer.

FIG. 4 is a diagram for explaining matrix multiplication computations.

FIG. 5 is a diagram illustrating an example of a specified condition referred to by a determiner in the present embodiment.

FIG. 6 is a diagram for explaining an example of a processing operation of a modifier in the present embodiment.

FIG. 7 is a flowchart illustrating an example of the processing operation of the information processing apparatus in the present embodiment.

### DESCRIPTION OF EMBODIMENT

### (Underlying Knowledge Forming Basis of the Present Disclosure)

The present inventors has found that the following problem arises with the Vision Transformer of NPL 2 described in “Background Art”.

The Transformer has been applied to various tasks, such as application to ChatGPT. The Transformer has been evaluated to be faster and more accurate than long shot-term memory (LSTM) networks. The Vision Transformer of NPL 2 is based on the above Transformer and boasts high inference performance for image recognition. However, when the Vision Transformer is incorporated into a system on a chip (SoC) included in an edge device, such as an in-vehicle electronic control unit (ECU), inference by the Vision Transformer may be slow.

In order to solve such a problem, an information processing apparatus according to a first aspect of the present disclosure includes: an input component that acquires a neural network including a Transformer; a determiner that determines whether one or more parameters used for the neural network satisfy a specified condition; and a modifier that modifies the one or more parameters to cause the one or more parameters to satisfy the specified condition, when the one or more parameters are determined not to satisfy the specified condition.

Thus, when the one or more parameters used for a neural network do not satisfy a specified condition corresponding to a system such as an SoC, for example, the parameters are modified to satisfy the specified condition. Therefore, even when the modified neural network is incorporated into the system, the one or more parameters used for the modified neural network satisfy the specified condition corresponding to the system, so that inference by the modified neural network can be fast. As a result, a neural network including a Transformer capable of performing inference at high speed can be generated.

In an information processing apparatus according to a second aspect, the specified condition may be a condition that a value indicated by each of the one or more parameters is a multiple of a specified value corresponding to the parameter.

Thus, when the value indicated by each of the one or more parameters is not a multiple of the specified value, the value is modified to be a multiple of the specified value. As a result, the inference speed of the neural network after modification can be appropriately made faster than that of the neural network before modification. As a result, a neural network including a Transformer capable of performing inference at high speed can be appropriately generated.

In an information processing apparatus according to a third aspect, the one or more parameters may include at least one of a sequence length, the number of patches, a feature length, or the number of classes.

Thus, a neural network including a Transformer capable of performing inference at high speed can be effectively generated.

In an information processing apparatus according to a fourth aspect, the one or more parameters may include, as a parameter, at least one of the number of rows or the number of columns of a matrix used in a computation of a matrix multiplication in the Transformer.

Thus, the number of rows or the number of columns is modified, thereby enabling an increase in the computation speed of the matrix multiplication included in the Transformer.

In an information processing apparatus according to a fifth aspect, the determiner may acquire system information related to a system that executes processing using the neural network, and determine the specified condition based on the system information.

Thus, the specified condition corresponding to the system can be determined for each system that executes the processing using the neural network. Therefore, no matter what type of system the modified neural network is incorporated into, the one or more parameters used for the modified neural network satisfy the specified condition corresponding to the system, so that inference by the modified neural network can be fast.

In an information processing apparatus according to a sixth aspect, the system may be a system on a chip (SoC).

Thus, for each SoC that executes processing using the neural network, a specified condition corresponding to the SoC can be determined. Therefore, no matter what type of SoC the modified neural network is incorporated into, the one or more parameters used for the modified neural network satisfy the specified condition corresponding to the SoC, so that inference by the modified neural network can be fast.

In an information processing apparatus according to a seventh aspect, the neural network may be a machine learning model for image recognition.

This makes it possible to generate a neural network including a Transformer capable of performing image recognition inference at high speed.

In an information processing apparatus according to an eighth aspect, the neural network may be a machine learning model for language processing.

This makes it possible to generate a neural network including a Transformer capable of performing language processing inference at high speed.

Note that these comprehensive or specific aspects may be implemented by a system, method, integrated circuit, computer program, or recording medium such as a computer-readable compact disc read-only memory (CD-ROM), or by any combination of the system, method, integrated circuit, computer program, or recording medium. The recording medium may be a non-temporary recording medium.

The following embodiment will be specifically described with reference to the drawings.

Note that the embodiment described below shows comprehensive or specific examples. The numerical values, shapes, materials, components, arrangement positions and connection forms of components, steps, order of steps, and the like shown in the following embodiment are examples and are not intended to limit the present disclosure. Among the components in the following embodiment, the components that are not described in the independent claims indicating the highest-level concepts will be described as optional components. Each figure is a schematic diagram and is not necessarily illustrated with strict accuracy. In each figure, the same reference numerals are assigned to the same components.

### EMBODIMENT

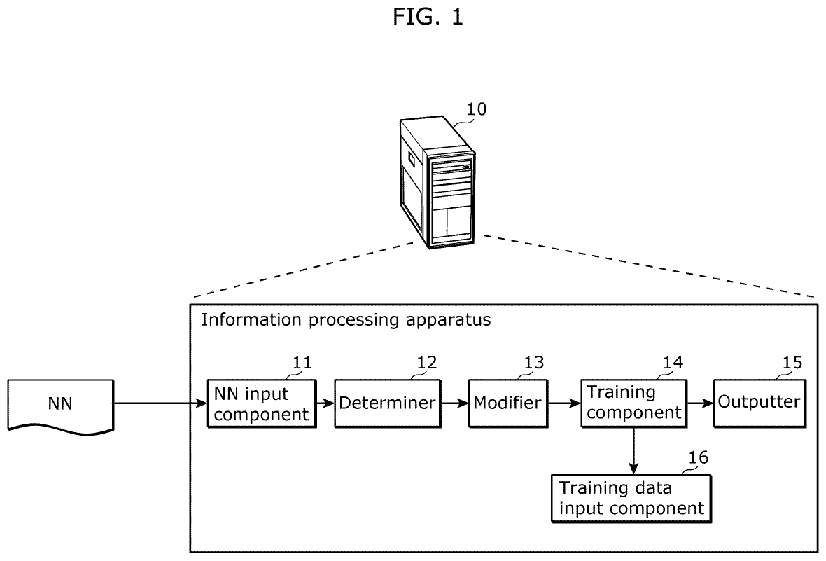

FIG. 1 is a block diagram illustrating an example of the configuration of an information processing apparatus in the present embodiment.

Information processing apparatus 10 in the present embodiment is a computer that modifies a neural network (hereinafter also referred to as NN) as necessary and performs machine learning on the modified NN. As illustrated in FIG. 1, such information processing apparatus 10 includes NN input component 11, determiner 12, modifier 13, training component 14, outputter 15, and training data input component 16.

NN input component 11 is an input component that acquires an NN. The NN is a machine learning model, more specifically, a deep learning model, and includes a Transformer. For example, NN input component 11 accepts an input operation by a user and acquires an NN from a recording medium such as a hard disk or memory in response to the input operation. Alternatively, NN input component 11 acquires an NN via a communication line such as the Internet.

Determiner 12 determines whether one or more parameters used for the NN acquired by NN input component 11 satisfy a specified condition.

When determiner 12 determines that the one or more parameters do not satisfy the specified condition, modifier 13 modifies the one or more parameters so that the one or more parameters satisfy the specified condition.

Training data input component 16 acquires training data. For example, training data input component 16 accepts an input operation by the user and acquires training data from a recording medium such as a hard disk or memory in response to the input operation. Alternatively, training data input component 16 acquires training data via a communication line such as the Internet.

Training component 14 acquires the NN from modifier 13 and acquires the training data from training data input component 16. The NN may have been modified, or may not have been modified, by modifier 13. Training component 14 performs machine learning on the NN using the training data to generate a trained model.

Outputter 15 outputs the trained model generated by training component 14 to the outside of information processing apparatus 10.

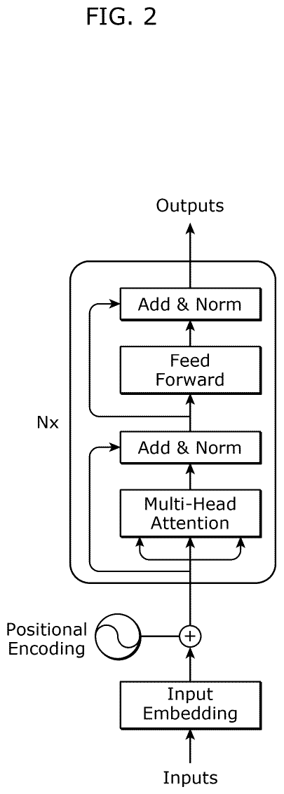

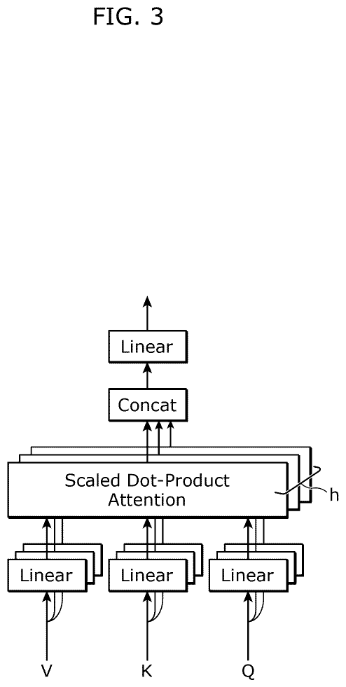

FIG. 2 illustrates the configuration of Transformer, and FIG. 3 illustrates the configuration of multi-head attention included in the Transformer. Note that the configurations illustrated in FIGS. 2 and 3 are those illustrated in NPL 1 described above.

As described above, the Transformer is a deep learning model and is a network architecture in which inputs and outputs are connected by multi-head attention and a feed-forward network. The multi-head attention includes scaled dot-product attention as illustrated in FIG. 3. In the scaled dot-product attention, matrix multiplication computations are performed.

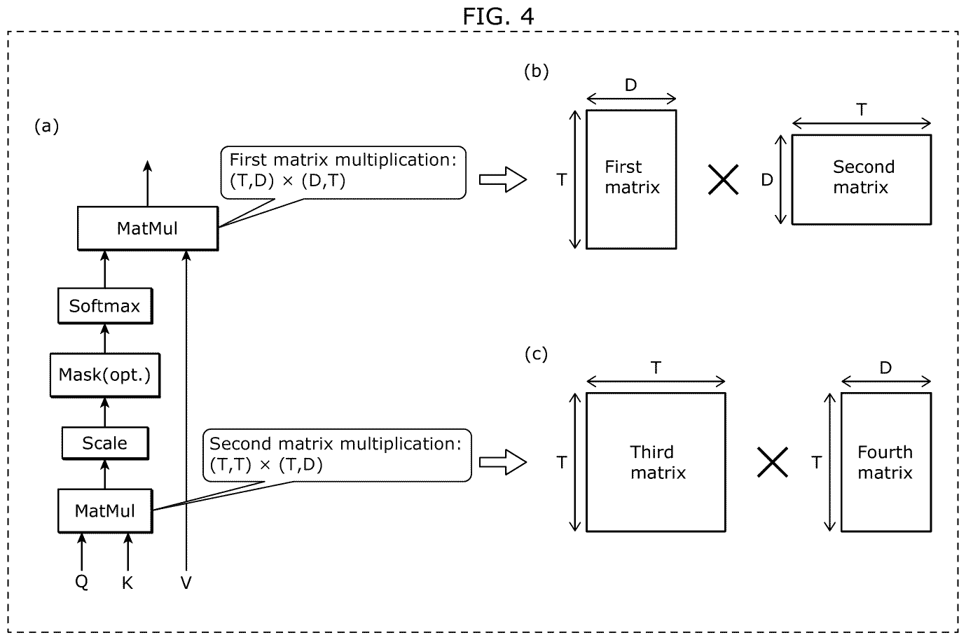

FIG. 4 is a diagram for explaining matrix multiplication computations.

The scaled dot-product attention includes two MatMuls as illustrated in (a) of FIG. 4. Each of the two MatMuls performs a matrix multiplication computation. For example, one of the two MatMuls performs a first matrix multiplication computation, and the other performs a second matrix multiplication computation. The first matrix multiplication is a multiplication of a matrix (T, D) and a matrix (D, T). Note that the matrix (T, D) is a first matrix consisting of T rows and D columns, and the matrix (D, T) is a second matrix consisting of D rows and T columns. The second matrix multiplication is a multiplication of a matrix (T, T) and a matrix (T, D). Note that the matrix (T, T) is a third matrix consisting of T rows and T columns, and the matrix (T, D) is a fourth matrix consisting of T rows and D columns. Each of D and T is a parameter that is used for the NN (specifically, the scaled dot-product attention of the Transformer) and represents an integer greater than or equal to 1. Each of the first matrix multiplication and the second matrix multiplication illustrated in FIG. 4 is simplified as a matrix multiplication in the case of the number of heads h=1 illustrated in FIG. 3.

Thus, the one or more parameters described above in the present embodiment include, as a parameter, at least one of the number of rows or the number of columns of the matrix used for the matrix multiplication computation in the Transformer.

Here, when such an NN is incorporated into the SoC included in the in-vehicle ECU, and at least one of parameters T or D does not satisfy the specified condition specific to the SoC, the computation speed of the matrix multiplication using those parameters may be slow.

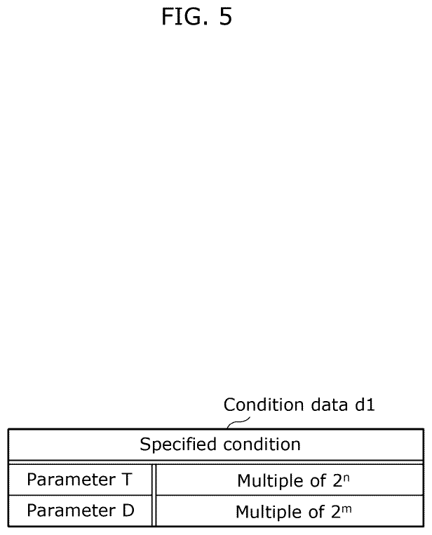

FIG. 5 is a diagram illustrating an example of the specified condition referred to by determiner 12 in the present embodiment.

Determiner 12 acquires, for example, condition data d1 indicating the specified condition illustrated in FIG. 5. The specified condition is a condition that a value indicated by each of the one or more parameters described above is a multiple of a specified value corresponding to the parameter. For example, the one or more parameters are at least one of parameters T or D. The specified value corresponding to parameter T is 2ⁿ, and the specified value corresponding to parameter D is 2^{m}. Note that n and m are each an integer greater than or equal to 1, and may be the same as or different from each other.

Specifically, determiner 12 selects condition data d1 corresponding to the SoC in which the NN is incorporated from a plurality of pieces of condition data d1 stored in the memory. Note that a combination of the two integers (n, m) consisting of n and m described above is different among the plurality of pieces of condition data d1. For example, determiner 12 acquires information indicating the manufacturer, part number, and the like of the SoC as system information, and selects condition data d1, previously associated with the manufacturer and part number indicated by the system information, from the plurality of pieces of condition data d1 described above. By selecting condition data d1 in this manner, determiner 12 determines the specified condition. Note that the memory described above may be provided in information processing apparatus 10 or outside information processing apparatus 10.

That is, determiner 12 in the present embodiment acquires system information related to the system for executing processing using the NN, and determines the specified condition based on the system information. The system is an SoC.

Then, determiner 12 determines whether each of parameters T and D satisfies the specified condition indicated by selected condition data d1. That is, determiner 12 determines whether parameter T is a multiple of 2ⁿ and whether parameter D is a multiple of 2^{m}. Parameter T satisfies the specified condition when parameter T is a multiple of 2ⁿ, and does not satisfy the specified condition when parameter T is not a multiple of 2ⁿ. Similarly, Parameter D satisfies the specified condition when parameter D is a multiple of 2^{m}, and does not satisfy the specified condition when parameter D is not a multiple of 2^{m}.

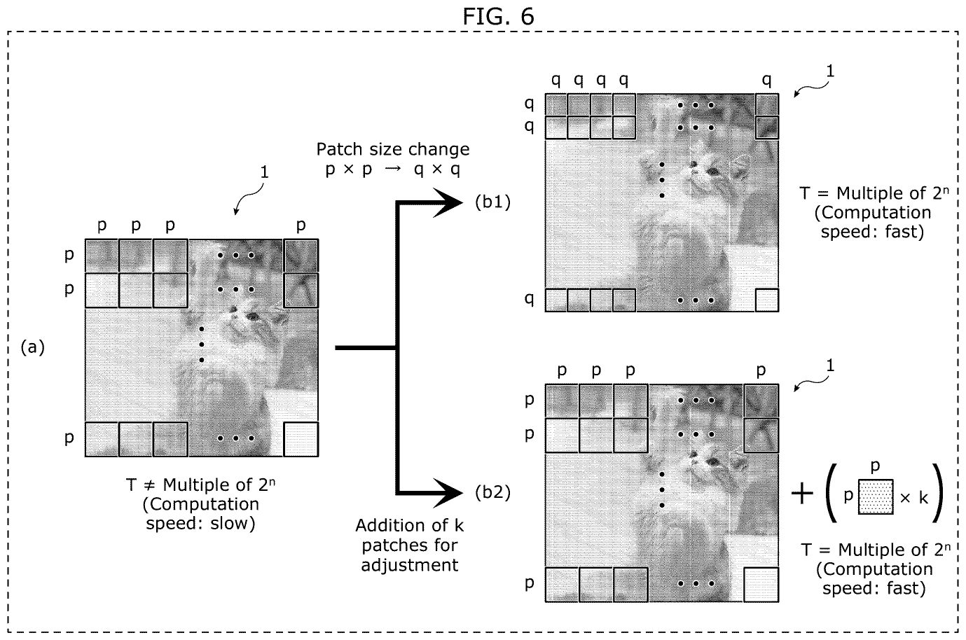

FIG. 6 is a diagram for explaining an example of the processing operation of modifier 13 in the present embodiment.

For example, when the NN is a machine learning model for image recognition by a Vision Transformer, parameter T is the number of patches constituting image 1 subjected to image recognition, as illustrated in (a) of FIG. 6. That is, the NN treats each of a plurality of blocks obtained by dividing image 1 into a grid pattern as a patch. Parameter T is the number of those patches (hereinafter also referred to as the number of patches). The patch is made up of p×p areas. Note that p is an integer greater than or equal to 2.

When determiner 12 determines that parameter T does not satisfy the specified condition, that is, parameter T is not a multiple of 2ⁿ, modifier 13 modifies parameter T to be a multiple of 2ⁿ. For example, as illustrated in (b1) of FIG. 6, modifier 13 changes the patch size from p×p areas to q×q areas, thereby increasing parameter T and modifying parameter T to be a multiple of 2ⁿ. Note that q is an integer different from p. Alternatively, as illustrated in (b2) of FIG. 6, modifier 13 adds k (k is an integer greater than or equal to 1) patches for adjustment to image 1, thereby increasing parameter T and modifying parameter T to be a multiple of 2ⁿ.

Thus, the NN is, for example, a machine learning model for image recognition. In this case, parameter T may be the number of patches constituting image 1. By modifying parameter T, for example, the computation speed of the second matrix multiplication can be increased. Parameter D used for the first matrix multiplication and the second matrix multiplication may be the feature length of a hidden layer. Modifier 13 may increase parameter D and modify parameter D to be a multiple of 2ⁿ in the same manner as parameter T. This enables an increase in the computation speeds of the first matrix multiplication and the second matrix multiplication described above.

In the Transformer for image recognition, the number of classes is used as parameter C. The number of classes is the number of types of objects recognizable through image recognition, and is used, for example, as the number of columns of matrix B in the matrix multiplication of matrix A×matrix B. Therefore, condition data d1 illustrated in FIG. 5 may indicate a specified condition that parameter C is a multiple of a specified value. The specified value is 2^{r} (r is an integer greater than or equal to 1). Accordingly, determiner 12 determines whether parameter C satisfies the specified condition, that is, whether parameter C is a multiple of the specified value. When determiner 12 determines that parameter C is not a multiple of the specified value, modifier 13 adds j dummy objects (j is an integer greater than or equal to 1) to the recognizable objects described above, thereby increasing parameter C and modifying parameter C to be a multiple of the specified value. This enables an increase in the computation speed of the matrix multiplication of matrix A×matrix B described above.

The NN may be a machine learning model for language processing. In this case, parameter T is referred to as a sequence length. By modifying parameter T, for example, the computation speed of the second matrix multiplication can be increased. Parameter D may be a feature length. Modifier 13 may increase parameter D and modify parameter D to be a multiple of 2ⁿ in the same manner as parameter T. This enables an increase in the computation speeds of the first matrix multiplication and the second matrix multiplication described above.

In a Transformer for language processing, the number of dimensions of an embedding vector is used as parameter C. The number of dimensions of the embedding vector is the number of dimensions in the embedding space of the vocabulary handled in language processing, and is used, for example, as the number of columns of matrix B in the matrix multiplication of matrix A×matrix B. Thus, as in the case described above, condition data d1 illustrated in FIG. 5 may indicate a specified condition that parameter C is a multiple of a specified value. Accordingly, determiner 12 determines whether parameter C satisfies the specified condition, that is, whether parameter C is a multiple of the specified value. When determiner 12 determines that parameter C is not a multiple of the specified value, modifier 13 adds j dummy dimensions of the embedding vector to the number of dimensions of the recognizable embedding vector described above, thereby increasing parameter C and modifying parameter C to be a multiple of the specified value. This enables an increase in the computation speed of the matrix multiplication of matrix A×matrix B described above.

Thus, the one or more parameters described above in the present embodiment include, as a parameter, at least one of the sequence length, the number of patches, the feature length, or the number of classes.

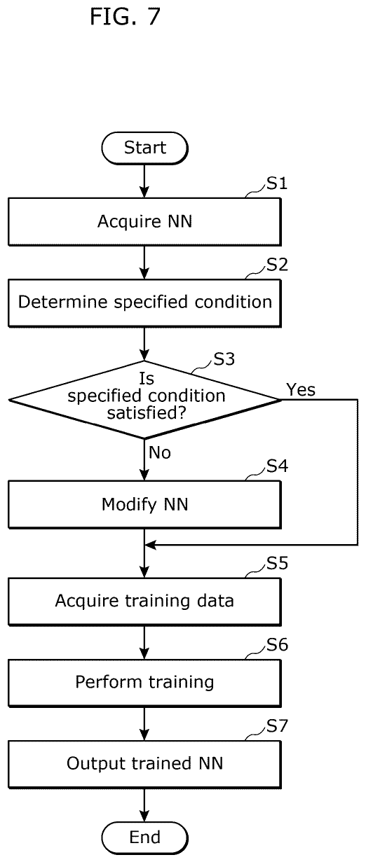

FIG. 7 is a flowchart illustrating an example of the processing operation of information processing apparatus 10 in the present embodiment.

First, NN input component 11 of information processing apparatus 10 acquires an NN (step S1). Next, determiner 12 acquires system information and selects condition data d1, previously associated with the system information, from the plurality of pieces of condition data d1. Thus, determiner 12 determines the specified condition corresponding to the NN to be the specified condition indicated in selected condition data d1 (step S2).

Then, determiner 12 determines whether one or more parameters used for the NN satisfy the specified condition (step S3). When determining that the one or more parameters do not satisfy the specified condition (No in step S3), determiner 12 modifies the one or more parameters, thereby modifying the NN (step S4). Determiner 12 outputs the modified NN to training component 14. On the other hand, when determining that the one or more parameters satisfy the specified condition (Yes in step S3), determiner 12 outputs the NN to training component 14 without modifying the NN.

Next, when acquiring the training data (step S5), training data input component 16 outputs the training data to training component 14. When acquiring the NN output from modifier 13, training component 14 performs training on the NN using the training data acquired by training data input component 16 (step S6). This generates a trained NN.

Then, outputter 15 outputs the generated trained NN to the outside of information processing apparatus 10 (step S7).

As described above, in the present embodiment, when one or more parameters used for an NN do not satisfy a specified condition corresponding to a system such as an SoC, for example, the parameters are modified to satisfy the specified condition. Therefore, even when the modified NN is incorporated into the system, the one or more parameters used for the modified NN satisfy the specified condition corresponding to the system, so that inference by the modified NN can be fast. As a result, an NN including a Transformer capable of performing inference at high speed can be generated.

In the present embodiment, the specified condition is a condition that a value indicated by each of the one or more parameters is a multiple of a specified value corresponding to the parameter. Thus, when the value indicated by each of the one or more parameters is not a multiple of the specified value, the value is modified to be a multiple of the specified value. As a result, the inference speed of the NN after modification can be appropriately made faster than that of the NN before modification. As a result, an NN including a Transformer capable of performing inference at high speed can be appropriately generated.

In the present embodiment, the one or more parameters in the present embodiment include, as a parameter, at least one of the sequence length, the number of patches, the feature length, or the number of classes. Thus, an NN including a Transformer capable of performing inference at high speed can be effectively generated.

In the present embodiment, the one or more parameters in the present embodiment include, as a parameter, at least one of the number of rows or the number of columns of a matrix used for the matrix multiplication computation in the Transformer. Thus, the number of rows or the number of columns is modified, thereby enabling an increase in the computation speed of the matrix multiplication included in the Transformer.

In the present embodiment, determiner 12 acquires system information related to the system for executing processing using the NN, and determines the specified condition based on the system information. In addition, the system is an SoC. Thus, for each system, that is, each SoC, for executing processing using the NN, a specified condition corresponding to the SoC can be determined. Therefore, no matter what type of SoC the modified NN is incorporated into, the one or more parameters used for the modified NN satisfy the specified condition corresponding to the SoC, so that inference by the modified NN can be fast.

In the present embodiment, the NN is a machine learning model for image recognition. This makes it possible to generate a neural network including a Transformer capable of performing image recognition inference at high speed. Alternatively, the NN is a machine learning model for language processing. This makes it possible to generate a neural network including a Transformer capable of performing language processing inference at high speed.

The information processing apparatus of the present disclosure has been described based on the embodiment described above, but the present disclosure is not limited to the embodiment. As long as the gist of the present disclosure is not departed from, the present disclosure may include forms in which various modifications conceived by those skilled in the art are applied to the above embodiment.

For example, in the above embodiment, the NN is a machine learning model for image recognition or language processing, but is not limited thereto and may be a machine learning model for other applications.

In the above embodiment, the SoC is exemplified as the system that executes processing using the NN, but the system is not limited to the SoC and may include a plurality of chips or a plurality of computers. The system may or may not be included in the in-vehicle ECU.

In the above embodiment, the one or more parameters to be modified are the sequence length, the feature length, and the like as described above, but parameters other than these may be modified, and parameters other than these may not be modified. The parameters other than these are, for example, the number of heads h illustrated in FIG. 3, the number of Transformer layers, the feature length of the hidden layer of the feed-forward network, and the feature length of the input layer. Note that the number of Transformer layers is the number of repetitions of Multi-Head Attention and Feed Forward illustrated in FIG. 2.

In the above embodiment, each component may be configured with dedicated hardware or implemented by executing a software program suitable for each component. Each component may be implemented by a program executor such as a central processing unit (CPU) or a processor reading and executing a software program recorded in a recording medium such as a hard disk or semiconductor memory. Here, the software implementing information processing apparatus 10 and the like of the above embodiment is a computer program for causing a computer to execute each step of the flowchart illustrated in FIG. 7.

Note that the following cases are also included in the present disclosure.

(1) At least one device described above is specifically a computer system formed of a microprocessor, read-only memory (ROM), random-access memory (RAM), hard disk unit, display unit, keyboard, mouse, and the like. The RAM or hard disk unit stores a computer program. The microprocessor operates according to the computer program, whereby the at least one device achieves its function. Here, the computer program is constituted by a combination of a plurality of command codes that indicate instructions to the computer to achieve a predetermined function.

(2) Some or all of the components constituting the at least one device may be formed of a single system large scale integrated circuit (LSI). The system LSI is an ultra-multifunctional LSI manufactured by integrating a plurality of components on a single chip and is specifically a computer system including a microprocessor, ROM, RAM, and the like. The RAM stores a computer program. The system LSI achieves its function by operating the microprocessor according to the computer program.

(3) Some or all of the components constituting the at least one device may be formed of an integrated circuit (IC) card or a single module detachable from the device. The IC card or the module is a computer system formed of a microprocessor, ROM, RAM, and the like. The IC card or the module may include the ultra-multifunctional LSI. The microprocessor operates according to the computer program, whereby the IC card or the module achieves its function. The IC card or the module may be tamper-resistant.

(4) The present disclosure may be the method described above. The present disclosure may be a computer program that causes a computer to implement the method, or a digital signal including the computer program.

(5) The present disclosure may be a computer program or a digital signal recorded on a computer-readable recording medium, such as a flexible disk, a hard disk, a CD-ROM, a digital versatile disc (DVD), a DVD-ROM, a DVD-RAM, a Blu-ray (registered trademark) disc (BD), a semiconductor memory, or the like. The present disclosure may be a digital signal recorded on these recording media.

The present disclosure may be implemented by transmitting a computer program or a digital signal via a telecommunication line, a wireless or wired communication line, a network represented by the Internet, a data broadcast, or the like.

The present disclosure may be implemented by another independent computer system by recording a program or a digital signal on a recording medium and transferring this, or by transferring a program or a digital signal via a network or the like.

Further Information about Technical Background to this Application

The disclosure of the following patent application including specification, drawings, and claims is incorporated herein by reference in their entirety: Japanese Patent Application No. 2024-156734 filed on Sep. 10, 2024.

### INDUSTRIAL APPLICABILITY

The information processing apparatus of the present disclosure is applicable to, for example, an apparatus or system that handles a neural network including a Transformer.

1. An information processing apparatus comprising:
a memory; and
a processor connected to the memory;
wherein, the processor:
acquires a neural network including a Transformer;
determines whether one or more parameters used for the neural network satisfy a specified condition; and
modifies the one or more parameters to cause the one or more parameters to satisfy the specified condition, when the one or more parameters are determined not to satisfy the specified condition.

2. The information processing apparatus according to claim 1,
wherein the specified condition is a condition that a value indicated by each of the one or more parameters is a multiple of a specified value corresponding to the parameter.

3. The information processing apparatus according to claim 1,
wherein the one or more parameters include, as a parameter, at least one of a sequence length, a total number of patches, a feature length, or a total number of classes.

4. The information processing apparatus according to claim 1,
wherein the one or more parameters include, as a parameter, at least one of a total number of rows or a total number of columns of a matrix used in a computation of a matrix multiplication in the Transformer.

5. The information processing apparatus according to claim 1,
wherein, in the determining on the one or more parameters, system information related to a system that executes processing using the neural network is acquired, and the specified condition is determined based on the system information.

6. The information processing apparatus according to claim 5,
wherein the system is a system on a chip (SoC).

7. The information processing apparatus according to claim 1,
wherein the neural network is a machine learning model for image recognition.

8. The information processing apparatus according to claim 1,
wherein the neural network is a machine learning model for language processing.

9. An information processing method executed by a computer, the information processing method comprising:
acquiring a neural network that includes a Transformer;
determining whether one or more parameters used for the neural network satisfy a specified condition; and
modifying the one or more parameters to cause the one or more parameters to satisfy the specified condition, when the one or more parameters are determined not to satisfy the specified condition.
